(19) United States
(12) Patent Application Publication
(10) Pub. No.: US 2026/0208359 A1
(43) Pub. Date: Jul. 23, 2026

(54) AUTONOMOUS MOBILE ROBOT FOR MANUFACTURING A VEHICLE

(71) Applicant: GM Global Technology Operations LLC, Detroit, MI (US)

(72) Inventors: Jesse Heidrich, Shelby Township, MI (US); James Butterworth, Mount Clemens, MI (US)

(73) Assignee: GM Global Technology Operations LLC, Detroit, MI (US)

(21) Appl. No.: 19/032,985

(22) Filed: Jan. 21, 2025

(51) Int. Cl. B25J 9/16; B25J 5/00

(52) U.S. Cl. CPC B25J 9/1679; B25J 5/007

(57) ABSTRACT

A system for manufacturing one or more products comprising an assembly line including a first end and a second end and one or more autonomous mobile robots (AMRs) each including a power reservoir and a communication device, the AMRs each communicatively coupled to one of the one or more products.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an autonomous mobile robot.

Autonomous mobile robots (AMRs) are designed to move materials within manufacturing facilities and warehouses, playing a crucial role in modern logistics and supply chain management. In general, AMRs can utilize simultaneous localization and mapping (SLAM) and obstacle avoidance to navigate complex environments. By autonomously planning routes and prioritizing tasks, AMRs enhance the operational efficiency of warehouses and manufacturing plants. Their ability to adapt to dynamic environments and coordinate with other robots further optimizes workflow and reduces the need for human intervention.

AMRs help streamline logistics by automating the transportation of goods, thus reducing labor costs and minimizing human error. They can be integrated with Internet of Things (IoT) networks, enabling seamless communication with other devices and systems, such as warehouse management systems (WMS) and manufacturing execution systems (MES). This connectivity allows for real-time data exchange and improved decision-making processes. Despite their numerous advantages, existing AMRs still face certain limitations and challenges that can be improved upon. Shortcomings of existing systems will be addressed by one or more aspects of the present disclosure.

### SUMMARY

In one configuration, a system for manufacturing a vehicle is provided and includes an assembly line extending between a first end and a second end, a communication conduit coupled to the assembly line and extending between the first end and the second end of the assembly line, the communication conduit defining an engagement surface between the first end and the second end, lineside equipment arranged adjacent to or on the assembly line between the first end and the second end and communicatively coupled to the communication conduit, and an autonomous mobile robot (AMR) configured to selectively engage with the assembly line and supply power to the vehicle. The AMR includes a body, one or more wheels coupled to the body, a power reservoir coupled to the body, and one or more contact points coupled to the body and communicatively coupled with the power reservoir.

The system may include one or more of the following optional aspects. For example, the one or more contact points can engage with the engagement surface of the communication conduit.

According to one aspect, the lineside equipment can include one or more contact points that are configured to engage with the engagement surface of the communication conduit.

According to another aspect, the AMR can include a storage device coupled to the body.

According to at least one example, the AMR can include one or more ports arranged on the body, the one or more ports are communicatively coupled to the power reservoir.

In another configuration, a system for manufacturing a vehicle is provided and includes an autonomous mobile robot (AMR) including a communication device and an assembly line communicatively coupling together the AMR and the vehicle so that data can be transmitted between the AMR and the vehicle.

The system may include one or more of the following optional aspects. For example, the assembly line can include a communication conduit extending between a first end and second end of the assembly line. The AMR and the vehicle can each include contact points that engage with the communication conduit.

According to another aspect, the AMR can include a power reservoir communicatively coupled to the communication device. The AMR can include one or more ports that are communicatively coupled to the power reservoir and the communication device.

In another configuration, a system for manufacturing one or more products is provided and includes an assembly line including a first end and a second end and one or more autonomous mobile robots (AMRs) each including a power reservoir and a communication device, the AMRs each communicatively coupled to the one or more products.

The system may include one or more of the following optional aspects. For example, the AMRs and the one or more products can be coupled together with a cable.

According to at least one aspect, the assembly line can include a communication conduit extending between the first end and the second end of the assembly line. Power can be transmitted from one of the AMRs to at least one of the products via the communication conduit. Data can be transmitted between one of the AMRs and at least one of the products via the communication conduit.

According to another aspect, the system can further include lineside equipment communicatively coupled to the communication conduit between the first end and the second end of the assembly line. The lineside equipment can be powered by the AMR via the communication conduit. Data can be transmitted between the lineside equipment and the AMR via the communication conduit.

According to at least one example, the communication conduit can be arranged below the product and the AMR.

According to another example, the communication conduit can be arranged above the product and the AMR.

### BRIEF DESCRIPTION OF THE DRAWINGS

The drawings described herein are for illustrative purposes only of selected configurations and are not intended to limit the scope of the present disclosure.

FIG. 1 is a front perspective view of a system including a vehicle and an autonomous mobile robot (AMR) according to principles of the present disclosure;

FIG. 2 is a side view of the vehicle and the AMR communicatively coupled via a communication conduit arranged in an assembly line;

FIG. 3 is a rear perspective view of the AMR of FIG. 1 according to principles of the present disclosure;

FIG. 4 is a cross-sectional view of a portion of the AMR and the assembly line of FIG. 2 along line 4-4;

FIG. 5 is another configuration of a system according to the principles of the present disclosure; and

FIG. 6 is another configuration of a system according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Heretofore, autonomous mobile robots (AMRs) have been designed primarily for moving materials (e.g., parts, boxes, crates, etc.) throughout manufacturing facilities and warehouses. Existing AMRs can communicate with surrounding infrastructure but do not communicate directly with products being manufactured on assembly lines or otherwise. As will be discussed in greater detail below, aspects of the present disclosure introduce an AMR that can be communicatively coupled to one or more products (e.g., vehicles) so that power and/or data can be transferred between the AMR and the product(s) during manufacturing. Communicating with the products in this manner can increase manufacturing capabilities along an assembly line that include, for example, powering the product(s), powering lineside equipment, uploading software to the product(s), testing electrical connections on the product(s), providing live connectivity to the product(s), etc. These capabilities can streamline production by reducing separate manufacturing events and can reduce a footprint for a manufacturing facility by shortening the assembly line.

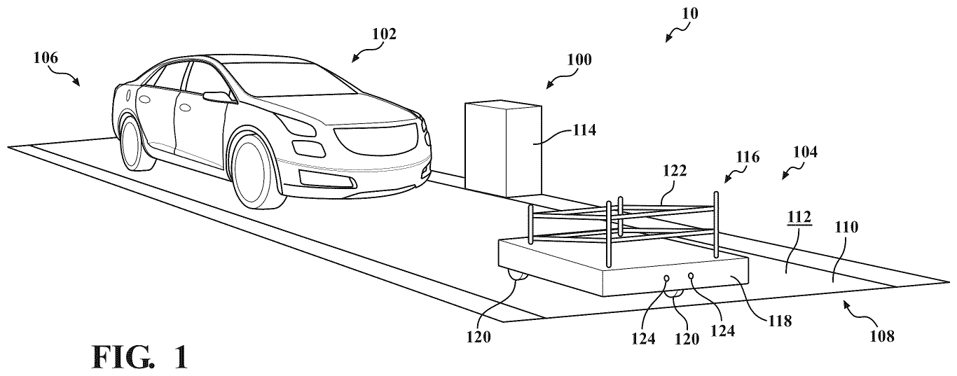

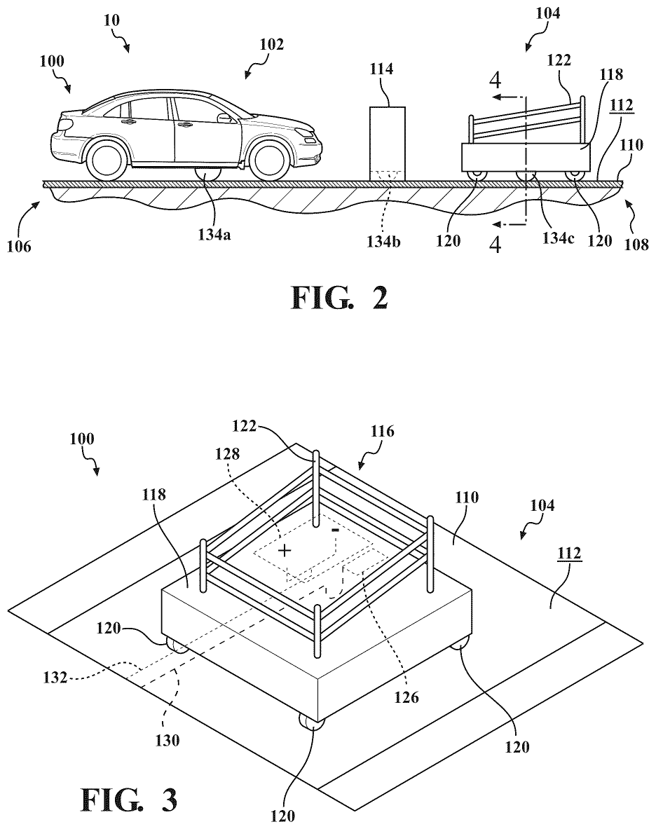

With reference to FIG. 1, an operating environment 10 is provided and includes a system 100 configured for manufacturing one or more products 102 (e.g., vehicles). The system 100 includes an assembly line 104 that extends between a first end 106 and a second end 108. The assembly line 104 includes a communication conduit 110 that can be configured to communicate data and/or electrical power (e.g., alternating current (AC) or direct current (DC)). The communication conduit 110 can be a temporary pathway or a permanent pathway that is integrally formed within the assembly line 104. In the present example, with reference to FIG. 2, at least a portion of the communication conduit 110 defines an engagement surface 112 that the products 102 can engage with between the first end 106 and the second end 108 of the assembly line 104.

Infrastructure (e.g., permanent or temporary) arranged in and throughout the operating environment 10 can be communicatively coupled to the communication conduit 110. With reference to FIGS. 1 and 2, the system 100 can include lineside equipment 114 arranged adjacent to the assembly line 104. The lineside equipment 114 can be configured to be communicatively coupled with the communication conduit 110. The lineside equipment 114 can include a variety of robotics, tooling stations, quality control equipment, material handling equipment, safety equipment, and/or storage solutions, for example.

With continued reference to FIGS. 1 and 2, the system 100 further includes at least one autonomous mobile robot (AMR) 116 that is configured to travel autonomously to and from the assembly line 104 and between the first end 106 and the second end 108 of the assembly line 104. In the present illustrative configuration, the AMR 116 is arranged in front of the product 102 or between the product 102 and the second end 108 of the assembly line 104, however, in other configurations, the AMR 116 can be arranged adjacent to the product 102 (i.e., on a right side or left side), behind the product 102 (i.e., between the product 102 and the first end 106 of the assembly line 104), or below the product 102 (i.e., underneath).

The AMR 116 includes a body 118, one or more wheels 120 coupled to the body 118 and, optionally, a storage device 122 coupled to the body 118 and configured to store and/or provide access to parts, components, etc. for manufacturing the product 102. The one or more wheels 120 can include two, three, four, or n-number of wheels. In other configurations, the one or more wheels 120 can include tracks, such as omnidirectional tracks. The body 118 can also include one or more ports 124 (e.g., charging ports, data ports, etc.) that are configured so that the AMR 116 can easily mate with a dock (not shown) for charging and data transmission, for example.

With reference to FIG. 3, the AMR 116 includes a communication device (e.g., a computer with memory hardware and processing hardware) 126 and a power reservoir (e.g., battery pack) 128. The communication device 126 can be configured to transmit and receive data 130 with the one or more products 102 and/or the lineside equipment 114. The power reservoir 128 can provide power 132 to the one or more products 102 and/or the lineside equipment 114. Powering the one or more products 102 and the lineside equipment 114 via the AMR 116 enables a range of manufacturing and assembly line advancements. For instance, live electrical connection testing can be conducted at any point along the assembly line 104. Additionally, supplying power to the products 102 in this manner enables mid-production movement of one or more aspects of the products 102 and that can reduce the need for layered-build assembly methods. Communicatively coupling the products 102 with the AMR 116 can enable live and autonomous data upload and download between the products 102 and the AMR 116. Thus, the AMR 116 can complete software-based tasks autonomously, which reduces the need for quality check stations and allows for real-time software updating throughout the manufacturing process. Powering the lineside equipment 114 can enable different build plans of the products 102 without having to retool a portion of the assembly line 104, for example.

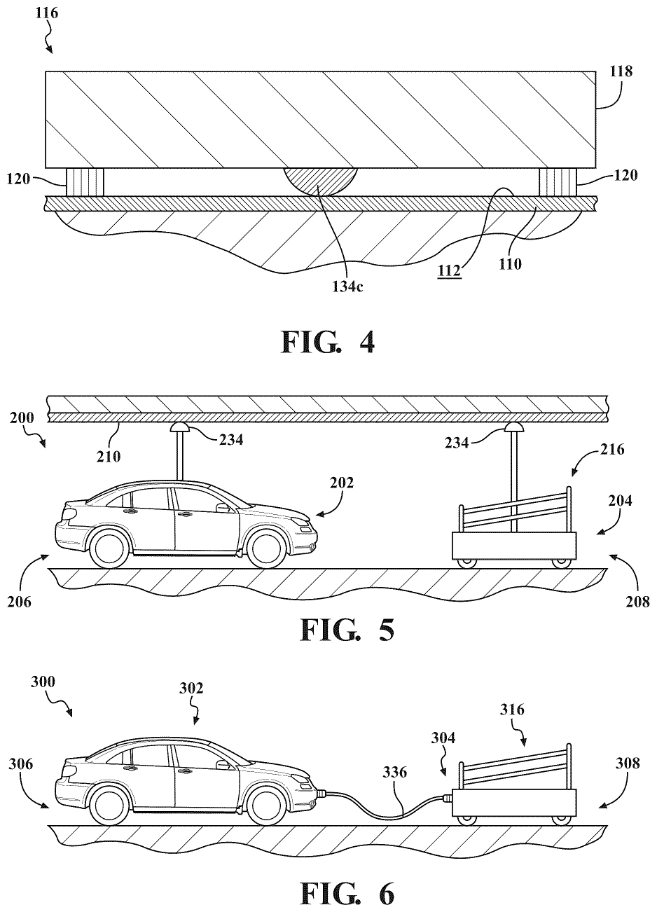

With reference to FIG. 2, the one or more products 102, the lineside equipment 114, and the AMR 116 each include a contact point 134a, 134b, 134c. Each contact point 134a, 134b, 134c can be configured to engage with and maintain continuous contact with the communication conduit 110 between the first end 106 and the second end 108 of the assembly line 104. More particularly, with reference to FIG. 4, at least a portion of the contact point 134c contacts or otherwise engages with the engagement surface 112 of the communication conduit 110. According to one aspect, the contact points 134a, 134b, 134c can be configured to receive power and/or data from the communication conduit 110 and transmit power and/or data to the communication conduit 110.

FIG. 5 illustrates another illustrative configuration of a system 200. This configuration is similar in many respects to the configuration of FIGS. 1-4. Accordingly, the descriptions of the configurations are hereby incorporated into one another, and description of subject matter common to the configurations generally may not be repeated.

Some operating environments are not configured to accommodate a communication conduit below (i.e., underneath) products being manufactured. With reference to FIG. 5, the system 200 includes infrastructure arranged overhead of products 202 between a first end 206 and a second end 208 of an assembly line 204. As shown, a communication conduit 210 is arranged with respect to the infrastructure arranged overhead of the products 202 between the first end 206 and the second end 208 of the assembly line 104. Similar to the aforementioned configurations, contact points 234 are communicatively coupled to the products 202 and an autonomous mobile robot (AMR) 216 and engage with and transmit power and/or data along the communication conduit 210.

FIG. 6 illustrates another illustrative configuration of a system 300. This configuration is similar in many respects to the configurations of FIGS. 1-4 and FIG. 5. Accordingly, the descriptions of the configurations are hereby incorporated into one another, and description of subject matter common to the configurations generally may not be repeated.

Some operating environments do not have on-site infrastructure that is necessary for a permanent communication conduit provided in the aforementioned configurations. With reference to FIG. 6, the system 300 includes an autonomous mobile robot (AMR) 316 tethered to one or more products 302 with a cable 336. The AMR 316 and the one or more products 302 can travel together between a first end 306 and a second end 308 of an assembly line 304, for example. While not readily shown in the figures, the AMR 316 can be tethered to lineside equipment with the cable 336 as well. Powering the one or more products 302 and/or the lineside equipment can reduce the need for lineside infrastructure and enable testing a factory or manufacturing concept and efficient work cell relocation (i.e., recommissioning). In other words, communicating with the products 302 and/or the lineside equipment in this manner can promote rapid setup and scaling of non-traditional manufacturing lines and reduce environmental footprint.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for manufacturing a vehicle, comprising:
an assembly line extending between a first end and a second end;
a communication conduit coupled to the assembly line and extending between the first end and the second end of the assembly line, the communication conduit defining an engagement surface between the first end and the second end;
lineside equipment arranged adjacent to or on the assembly line between the first end and the second end and communicatively coupled to the communication conduit; and
an autonomous mobile robot (AMR) configured to selectively engage with the assembly line and supply power to the vehicle, the AMR comprising:
a body,
one or more wheels coupled to the body,
a power reservoir coupled to the body, and
one or more contact points coupled to the body and communicatively coupled with the power reservoir.

2. The system of claim 1, wherein the one or more contact points engage with the engagement surface of the communication conduit.

3. The system of claim 1, wherein the lineside equipment includes one or more contact points that are configured to engage with the engagement surface of the communication conduit.

4. The system of claim 1, wherein the AMR includes a storage device coupled to the body.

5. The system of claim 1, wherein the AMR includes one or more ports arranged on the body, the one or more ports being communicatively coupled to the power reservoir.

6. A system for manufacturing a vehicle, comprising:
an autonomous mobile robot (AMR) including a communication device; and
an assembly line communicatively coupling together the AMR and the vehicle so that data can be transmitted between the AMR and the vehicle.

7. The system of claim 6, wherein the assembly line includes a communication conduit extending between a first end and second end of the assembly line.

8. The system of claim 7, wherein the AMR and the vehicle each include contact points that engage with the communication conduit.

9. The system of claim 6, wherein the AMR includes a power reservoir communicatively coupled to the communication device.

10. The system of claim 9, wherein the AMR includes one or more ports that are communicatively coupled to the power reservoir and the communication device.

11. A system for manufacturing one or more products, comprising:
an assembly line including a first end and a second end; and
one or more autonomous mobile robots (AMRs) each including a power reservoir and a communication device, the AMRs each communicatively coupled to the one or more products.

12. The system of claim 11, wherein the AMRs and the one or more products are each coupled together with a cable.

13. The system of claim 11, wherein the assembly line includes a communication conduit extending between the first end and the second end of the assembly line.

14. The system of claim 13, wherein power is transmitted from one of the AMRs to at least one of the products via the communication conduit.

15. The system of claim 14, wherein data is transmitted between one of the AMRs and at least one of the products via the communication conduit.

16. The system of claim 13, further comprising lineside equipment communicatively coupled to the communication conduit between the first end and the second end of the assembly line.

17. The system of claim 16, wherein the lineside equipment is powered by the AMR via the communication conduit.

18. The system of claim 17, wherein data is transmitted between the lineside equipment and the AMR via the communication conduit.

19. The system of claim 13, wherein the communication conduit is arranged below the product and the AMR.

20. The system of claim 13, wherein the communication conduit is arranged above the product and the AMR.
